(19) United States
(12) Patent Application Publication
(10) Pub. No.: US 2021/0163207 A1
(43) Pub. Date: Jun. 3, 2021

(54) FOOD PACKAGING

(71) Applicants: OR BLUMENFELD, HOLON (IL); RAN SIMANTOV, MIAMI, FL (US)

(72) Inventors: OR BLUMENFELD, HOLON (IL); RAN SIMANTOV, MIAMI, FL (US)

(21) Appl. No.: 16/795,609

(22) Filed: Feb. 20, 2020

(30) Foreign Application Priority Data
Dec. 2, 2019 (IL) 271123

(51) Int. Cl. B65D 81/26; B32B 15/12; B65D 65/40; B32B 7/12; B32B 1/00; B65D 85/36; B32B 15/08; B32B 15/20

(52) U.S. Cl. CPC B65D 81/264; B32B 15/12; B65D 65/40; B32B 7/12; B32B 1/00; B32B 2439/46; B32B 15/08; B32B 15/20; B32B 2439/70; B65D 2585/366; B65D 85/36

(57) ABSTRACT

A food packaging having an interior layer of absorbent material of at least 5 weight absorption levels.

### FIELD

The invention relates to the field of packaging for oily food.

### BACKGROUND

FIG. 1 schematically illustrates a fries packaging, according to the prior art.

The packaging is made of a paperboard whose exterior layer 15 comprises a print (not shown in the figure). The used paperboard has some absorption ability, so that the oil of the fries does not reach the exterior side of the packaging during a period which the user eats the fries, i.e., about 10-15 minutes.

Furthermore, the packaging materials used presently are not intended to absorb a “meaningful” amount of residue from frying oil until the time of consumption, which defects the taste of the fried food, and may harm the health of a user thereof.

Furthermore, snacks packaging is usually made of plastic or aluminum foil, which do not have absorption ability. As a result, users of such snacks consume the entire oil absorbed in the snacks. Consequently snacks manufacturers expend much development effort to determine how to use as little oil as possible in their products.

### SUMMARY

The invention, in embodiments thereof, is directed to a food packaging, comprising: an interior layer of absorbent material of at least 5 weight absorption levels.

According to one embodiment of the invention, a thickness of the interior layer is at least 1 mm.

The food packaging may further comprise at least one layer of paper of recycled pulp, for providing stiffness to the packaging.

The food packaging may further comprise an impervious layer, for preventing from oil and liquids to reach to an outer side of the packaging, such as oily foil and aluminum foil.

The food packaging may be of an open type (such as French fries and popcorn packaging), as well of closed type.

The food packaging may further comprise a printed layer, such as made of printed oriented paper.

According to one embodiment of the invention, an exterior layer of the packaging is made of transparent plastic, for allowing a printed layer underneath to be seen.

The interior layer may cover the entire interior layers of the packaging, or only a bottom thereof.

According to one embodiment of the invention, the entire interior layer is glued to the packaging.

According to another embodiment of the invention, the interior layer is pointwise glued to the packaging.

According to one embodiment of the invention, the interior layer is attached to the packaging by a heating process.

The packaging may be in a form of a box, bag, sheet, and other.

Of course, the packaging can be used for any kind of fried, cooked food, raw food, etc., such as French fries, popcorn, doughnut, hamburger, snacks, sandwich, roll, pita, cookies, pizza, pastries and bread.

The foregoing embodiments of the invention have been described and illustrated in conjunction with systems and methods thereof, which are meant to be merely illustrative, and not limiting.

### BRIEF DESCRIPTION OF THE DRAWINGS

Embodiments, features, and aspects of the invention are described herein in conjunction with the following drawings:

FIG. 1 schematically illustrates a fries packaging, according to the prior art.

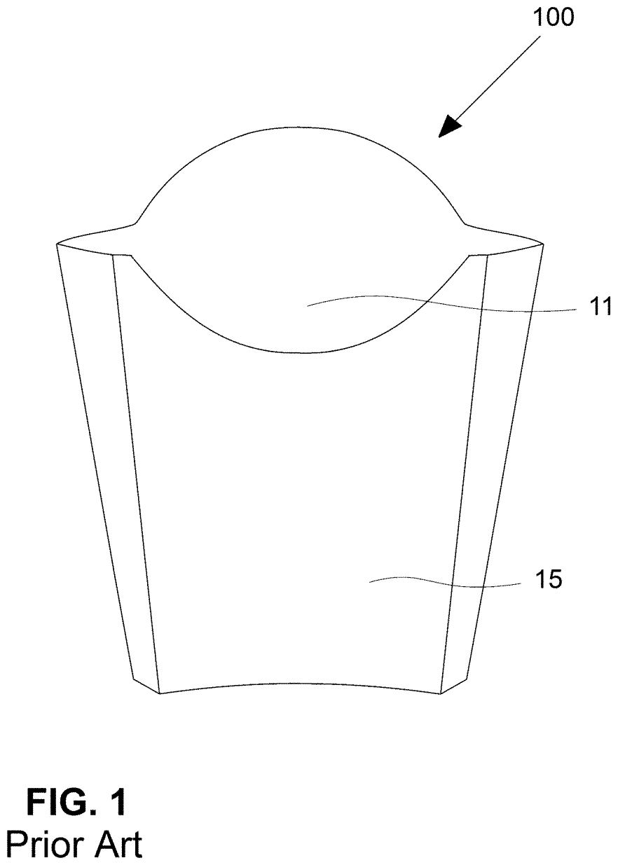

FIG. 2 schematically illustrates an open food packaging 101, according to one embodiment of the invention.

FIG. 3 schematically illustrates a closeable food packaging 102, according to one embodiment of the invention.

FIG. 4 schematically illustrates an open packaging board in which one wall thereof is exploded, according to one embodiment of the invention.

FIG. 5 schematically illustrates a snacks packaging, according to one embodiment of the invention.

FIG. 6 schematically illustrates a food item packaging, according to one embodiment of the invention.

It should be understood that the drawings are not necessarily drawn to scale.

### DETAILED DESCRIPTION

The invention will be understood from the following detailed description of embodiments which are meant to be descriptive and not limiting. For the sake of brevity, some well-known features, methods, systems, procedures, components, circuits, and so on, are not described in detail.

The term “absorbent material” refers herein to a porous material that draws fluid molecules into its interior volume, and retains this fluid within its structure due to attractive forces between the fluid and pore molecules.

The term “volume absorption level of absorbent material” is defined herein as the ratio of the volume of the absorbent material to the volume of liquid absorbed therein.

The term “weight absorption level of absorbent material” is defined herein as the ratio of the weight of the absorbent material to the weight of liquid absorbed therein.

Thus, a 5 weight absorption levels refers to an ability of 1 gr of an absorbent material to absorb 5 gr of fluid; and a 5 volume absorption levels refers to an ability of 1 cc of an absorbent material to absorb 5 cc of fluid.

According to an embodiment of the invention, the absorbent absorption ability of the absorbent material an absorbent layer is made of is at least 5 weight levels. In other words, if a layer of absorbent material weights 1 gr, it can absorb 5 gr of liquids.

The thickness of an absorbent layer can be determined, for example, by trial and error. Experiments made by the Applicant have shown that a thickness of 1 mm of absorbent material of 5 weight levels is sufficient for absorbing oil of French fries.

Of course, the absorption ability depends on the food placed in the packaging box, but according to experiments made by the Applicant, an absorption ability of 5 weight levels is suitable for French fries, and other fried foods, pizza, and so on.

Higher absorption capacity of a food packaging reduces its consumer health risk.

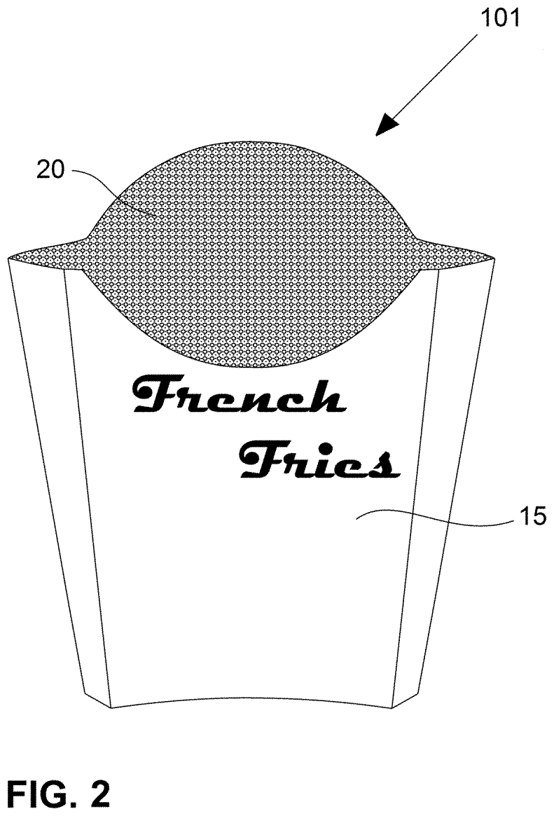

FIG. 2 schematically illustrates an open food packaging 101, according to one embodiment of the invention.

The packaging is of potato chips (“French fries”).

The inner layer 20 is of oil absorbent of 5 weight or volume absorption levels. Thus, the packaging absorbs oil and fluids of the food disposed therein.

A popcorn packaging may be designed in the same manner, i.e., an open packaging in which its inner side is made of absorbent material of at least 5 weight absorption levels.

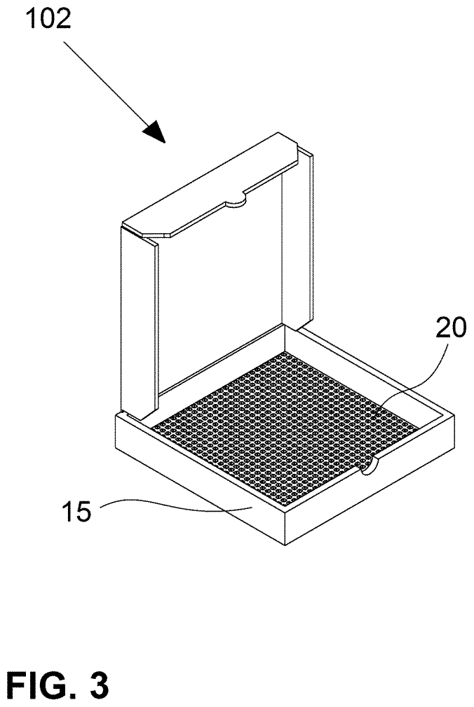

FIG. 3 schematically illustrates a closeable food packaging 102, according to one embodiment of the invention.

According to this embodiment of the invention, on the bottom wall of the packaging 102 is disposed a board in which its upper layer is an absorbent layer 20 of 5 weight absorption levels.

The fluid absorbent layer may be glued to the inner side of the bottom of the walls of the packaging, or to be an integral layer of the packaging walls.

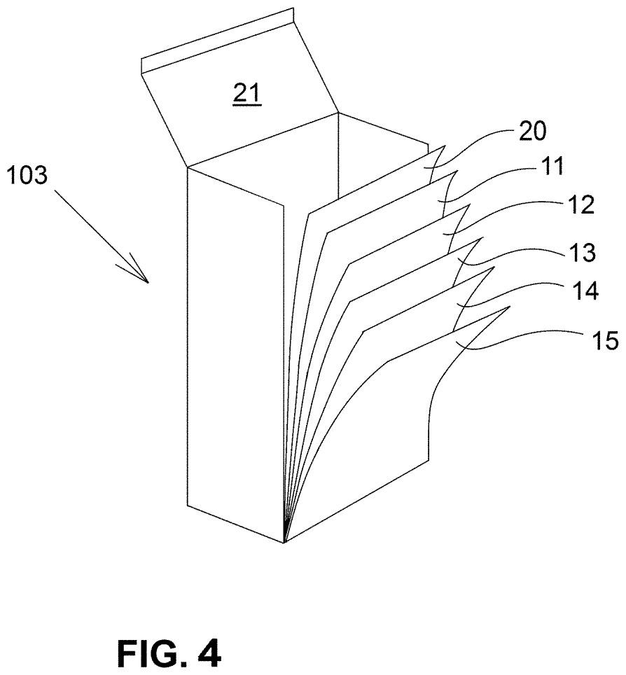

FIG. 4 schematically illustrates an open packaging board in which one wall thereof is exploded, according to one embodiment of the invention.

It may comprise the same layers as the prior art; however, it comprises an additional layer 20, which is an absorbent layer. Layer 20 is the most inner layer of the packaging.

Layer 20 is made of absorbent material of at least 5 weight levels. Thus, an absorbent material of 1 gr can absorb 5 gr of oil and other liquids.

The inner layer(s) are usually intended to provide some sterility and impervious to the stored food, and therefore are usually made of plastic 11 and aluminum 12. The aluminum foil 12 may be used also as a barrier for heating and imperviousness. Liquid packaging is normally sealed to heat.

Alternatively, other impervious materials can be used, such as a layer of oily material.

The middle layer(s) are usually intended to provide some stiffness to the packaging, and therefore are made of paper of recycled pulp 13.

The outer layer(s) are usually intended to provide “look and feel”, and therefore are made, for example, from a paper printed layer 14 and transparent plastic 15. The printed layer may be made of chemical pulp of quality that is suitable for the printing applications.

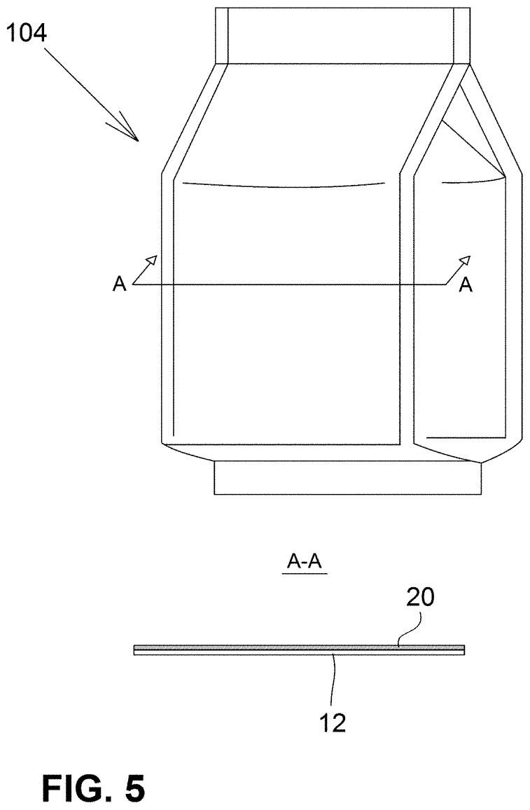

FIG. 5 schematically illustrates a snacks packaging, according to one embodiment of the invention.

The figure also illustrates a cross-section A-A across the packaging.

The packaging is in form of a bag made of an exterior an aluminum layer 12, and an interior absorbent layer 20 of 5 weight absorption levels. The exterior layer may also be of plastic, cellophane, or other impervious material.

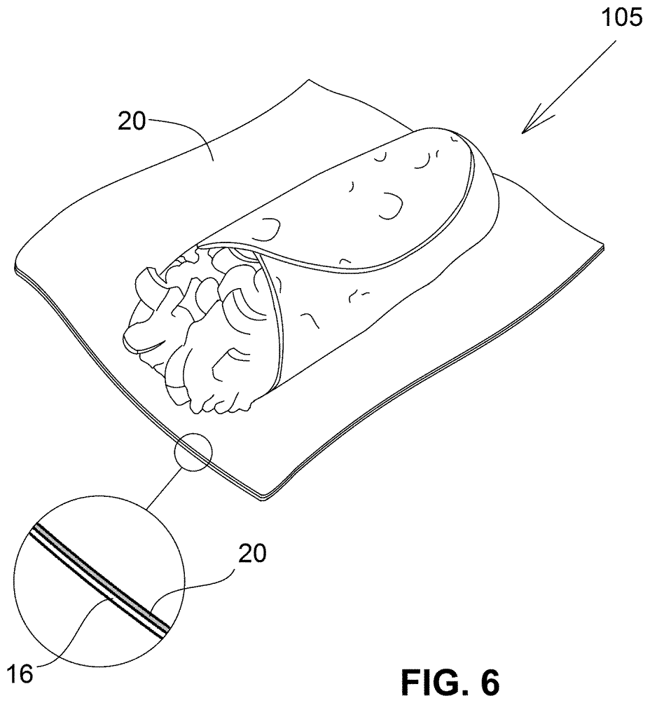

FIG. 6 schematically illustrates a food item packaging, according to one embodiment of the invention.

The packaging is a roll in which is placed Shawarma (https://en.wikipedia.org/wiki/Shawarma). However, the food item may be a doughnut, sandwich, hamburger, and actually any food dish served in pita, roll, loaf, and other kind of bread.

The packaging is in a form of a sheet comprising an inner absorbent layer 20 of 5 weight absorption levels, and an outer layer 13 made of paper of recycled pulp, whether printed or not.

In the figures and/or description herein, the following reference numerals (Reference Signs List) have been mentioned:
numeral 100 denotes a food packaging, according to the prior art;
numeral 101 denotes an open food packaging, according to one embodiment of the invention;
numeral 102 denotes a closeable food packaging, according to one embodiment of the invention;
numeral 103 denotes a closeable food packaging, according to one embodiment of the invention;
numeral 104 denotes a food packaging in a form of a bag, according to one embodiment of the invention;
numeral 105 denotes a food packaging in a form of a sheet, according to one embodiment of the invention;
numeral 11 denotes a plastic layer;
numeral 12 denotes an aluminum layer (foil);
numeral 13 denotes a paper of recycled pulp layer;
numeral 14 denotes a printed paper layer;
numeral 15 denotes a transparent plastic layer;
numeral 16 denotes a roll of Shawarma;
numeral 20 denotes an absorbent layer; and
numeral 21 denotes a lid.

The foregoing description and illustrations of the embodiments of the invention has been presented for the purposes of illustration. It is not intended to be exhaustive or to limit the invention to the above description in any form.

Any term that has been defined above and used in the claims, should be interpreted according to this definition.

What is claimed is:

1. A food packaging, comprising:
an interior layer of absorbent material of at least 5 weight absorption levels.

2. The food packaging according to claim 1, wherein a thickness of said interior layer is at least 1 mm.

3. The food packaging according to claim 1, further comprising at least one layer of pulp of recycled paper, for providing stiffness to said packaging.

4. The food packaging according to claim 1, further comprising an impervious layer, for preventing from oil and liquids to reach to an outer side of said packaging.

5. The food packaging according to claim 4, wherein said impervious layer is made of oily foil.

6. The food packaging according to claim 1, further comprising aluminum layer, for providing impervious and sterility to food placed in said packaging.

7. The food packaging according to claim 1, wherein said packaging is open.

8. The food packaging according to claim 4, wherein said packaging is closed.

9. The food packaging according to claim 1, further comprising a printed layer.

10. The food packaging according to claim 1, wherein an exterior layer thereof is made of transparent plastic.

11. The food packaging according to claim 1, wherein said interior layer is only at a bottom of said packaging.

12. The food packaging according to claim 1, wherein said interior layer is glued to said packaging.

13. The food packaging according to claim 1, wherein said interior layer is pointwise glued to said packaging.

14. The food packaging according to claim 1, wherein said interior layer is attached to said packaging by a heating process.

15. The food packaging according to claim 1, wherein said packaging is in form of a bag.

16. The food packaging according to claim 1, wherein said packaging is in a form of a sheet.

17. The food packaging according to claim 1, wherein said absorption ability of said absorbent material and thickness thereof is adapted for a food selected from a group consisting of: French fries, popcorn, doughnut, hamburger, snacks, sandwich, roll, pita, cookies, pizza, pastries and bread.
